(19) United States
(12) Patent Application Publication
(10) Pub. No.: US 2025/0163192 A1
(43) Pub. Date: May 22, 2025

(54) METHOD AND DEVICE FOR MODIFYING FLUORORESIN

(71) Applicant: Ushio Denki Kabushiki Kaisha, Tokyo (JP)

(72) Inventor: Akihiro SHIMAMOTO, Tokyo (JP)

(73) Assignee: Ushio Denki Kabushiki Kaisha, Tokyo (JP)

(21) Appl. No.: 18/729,053

(22) PCT Filed: Oct. 31, 2022
(86) PCT No.: PCT/JP2022/040657

§ 371 Date: Jul. 15, 2024

(30) Foreign Application Priority Data
Jan. 26, 2022 (JP) 2022-009863

(51) Int. Cl. C08F 8/02; B01J 19/12; C08F 8/06

(52) U.S. Cl. CPC C08F 8/02; B01J 19/123; C08F 8/06; B01J 2219/0869; B01J 2219/0875; B01J 2219/1203

(57) ABSTRACT

The method for modifying a fluororesin includes two steps. In a first step, a first gas containing an organic compound including an oxygen atom is irradiated with ultraviolet light exhibiting intensity in at least a wavelength region of 205 nm or less, and the first gas that has been irradiated with the ultraviolet light is brought into contact with a fluororesin. In a second step, a second gas containing oxygen molecules is irradiated with the ultraviolet light, and the second gas that has been irradiated with the ultraviolet light is brought into contact with the fluororesin. The modification device includes: at least one gas supply port for supplying a first gas containing an organic compound including an oxygen atom and a second gas containing oxygen molecules; and a light source that emits ultraviolet light exhibiting intensity in a wavelength region of 205 nm or less.

### TECHNICAL FIELD

The present invention relates to a method and device for modifying a fluororesin.

### BACKGROUND ART

A method for hydrophilically modifying a hydrophobic fluororesin has been known.

Patent Document 1 discloses a method in which a substrate 91 made of a fluororesin is brought into contact with the surface of an aqueous ethanol solution 90, and a principal surface 92 of the substrate 91 in contact with the aqueous ethanol solution 90 is irradiated with ultraviolet light from an ArF excimer laser to hydrophilically modify the principal surface 92 (see FIG. 8).

### PRIOR ART DOCUMENT

### Patent Document

Patent Document 1: JP-A-6-279590

### SUMMARY OF THE INVENTION

### Problems to be Solved by the Invention

Patent Document 1 discloses two methods for irradiating the principal surface 92 with ultraviolet light. As shown in FIG. 8, the first method is a method in which a light source 95a is disposed above a container 93 that stores the aqueous ethanol solution 90 so that the principal surface 92 is irradiated with ultraviolet light L8 that has entered the substrate 91 from the back surface side and passed through the substrate 91. The second method is a method in which a light source 95b is disposed below the container 93 so that the principal surface 92 is irradiated with ultraviolet light L9 that has passed through the container 93 and the aqueous ethanol solution 90.

When the first method is adopted, there are two problems: one is that since the ultraviolet light L8 passes through the substrate 91, the ultraviolet light L8 is absorbed by the substrate 91 so that the amount of the ultraviolet light L8 that reaches the principal surface 92 reduces; and the other is that the fluororesin constituting the substrate 91 is altered by the ultraviolet light L8. When the second method is adopted, there is a problem that the ultraviolet light L9 is absorbed or scattered by the aqueous ethanol solution 90 when passing through the container 93 and the aqueous ethanol solution 90 so that the amount of the ultraviolet light L9 that reaches the principal surface 92 significantly reduces.

In light of these problems, it is an object of the present invention to provide an improved method and device for modifying a fluororesin.

### Means for Solving the Problems

The present invention is directed to a method for modifying a fluororesin, the method including:

a first step in which a first gas containing an organic compound including an oxygen atom is irradiated with ultraviolet light exhibiting intensity in at least a wavelength region of 205 nm or less, and the first gas that has been irradiated with the ultraviolet light is brought into contact with a fluororesin; and

a second step in which a second gas containing oxygen molecules is irradiated with the ultraviolet light, and the second gas that has been irradiated with the ultraviolet light is brought into contact with the fluororesin.

In the present invention, ultraviolet light exhibiting intensity in at least a wavelength region of 205 nm or less is used for radicalization of a first gas containing an organic compound including an oxygen atom in the first step and for radicalization of a second gas containing oxygen molecules in the second step.

Terms used herein will be described. The term “radical” refers to an atom or molecule having an unpaired electron. Although details will be described later, a radical has an unpaired electron and is therefore highly reactive with another molecule. The term “radicalization” refers to producing a radical from a radical source. The term “organic compound including an oxygen atom” means that the molecular structure of the organic compound has at least one oxygen atom.

As for the radicalization of the first gas, in Patent Document 1, the ultraviolet light from the ArF excimer laser is used for radicalization of ethanol in the aqueous ethanol solution. On the other hand, in the present invention, the ultraviolet light exhibiting intensity in at least a wavelength region of 205 nm or less is used for radicalization of the first gas containing an organic compound including an oxygen atom in the first step. Since a radical source is not present in a liquid and is a gas, produced radicals are less likely to be deactivated. Further, in the present invention, since a light path of the ultraviolet light to an irradiated region is filled with not a liquid but a gas, the ultraviolet light is less likely to be scattered or absorbed as compared to when the light path is filled with a liquid so that attenuation of the ultraviolet light is reduced.

As for the radicalization of the second gas, the ultraviolet light exhibiting intensity in at least a wavelength region of 205 nm or less is attenuated when oxygen molecules are present in the light path of the ultraviolet light, and therefore it has heretofore been recommended that the ultraviolet light is used in, for example, a vacuum environment by removing oxygen molecules from the light path as much as possible. On the other hand, in the present invention, oxygen radicals are produced by actively irradiating oxygen molecules with ultraviolet light. The produced oxygen radicals are used for hydrophilization by allowing them to act on an object to be processed, or the produced oxygen radicals are bonded to oxygen molecules to produce ozone, and the ozone is used for hydrophilization by allowing it to act on an object to be processed.

In the present invention, radicals are produced in each of the first step and the second step, and hydrophilization can be achieved by the radicals produced in each of the first step and the second step. Therefore, the surface of the fluororesin is more hydrophilized than ever before. The hydrophilization of surface of the fluororesin refers to processing for enhancing the affinity of the surface for water molecules. The hydrophilicity of surface of the fluororesin is enhanced by replacing a fluorine atom present on the surface of the fluororesin with a polar functional group containing no fluorine atom. Although details will be described later, when the fluororesin is modified from hydrophobic to hydrophilic, for example, the fluororesin can tightly be joined with another material.

After the first step, the first gas may be discharged from a processing chamber before the second step is performed in the processing chamber. This makes it possible to prevent mixing of the first gas and the second gas to reduce the risk of combustion of the first gas.

The first step and the second step may be performed at the same time by mixing the first gas and the second gas in such a manner that at least one of the organic compound and oxygen gas satisfies that a concentration thereof is less than a flammability limit, and

irradiating a mixed gas obtained by mixing the first gas and the second gas with the ultraviolet light. By using the mixed gas, the first step and the second step are performed at the same time. This makes it possible to reduce processing time and simplify a device and a system.

At least one of the first step and the second step may be performed by irradiating a gas in contact with the fluororesin with the ultraviolet light. In a case where a gas in contact with the fluororesin is irradiated with the ultraviolet light, for example, a light source that emits the ultraviolet light and the fluororesin are disposed with a narrow space being interposed therebetween, and in such a state, the fluororesin is irradiated with the ultraviolet light from the light source while the gas is allowed to flow through the space. This makes it possible to radicalize the gas that is present near the surface of the fluororesin or inside the fluororesin. As a result, many of produced radicals can be brought into contact with the fluororesin.

The second gas may be air. Air is present in the atmosphere, and therefore it is not necessary to separately prepare a supply source.

The organic compound may contain at least one of a hydroxy group, a carbonyl group, and an ether bond. In this case, a functional group containing at least one of a hydroxy group, a carbonyl group, and an ether bond can be formed on the surface of the fluororesin, and therefore high hydrophilicity can be imparted to the surface of the fluororesin.

The organic compound may contain at least one selected from the group consisting of an alcohol, a ketone, an aldehyde, a carboxylic acid, and a phenol.

The organic compound may contain at least one selected from the group consisting of an alcohol having 10 or less carbon atoms and a ketone having 10 or less carbon atoms.

The organic compound may contain at least one selected from the group consisting of an alcohol having 2 or more and 4 or less carbon atoms and acetone. An alcohol having 2 or more and 4 or less carbon atoms and acetone are excellent in easy availability and economic efficiency. An alcohol having 2 or more and 4 or less carbon atoms is excellent in safety and ease of handling. Acetone has a high vapor pressure, which makes it easy to form a relatively high concentration atmosphere.

The ultraviolet light may be produced by a xenon excimer lamp.

The present invention is also directed to a modification device including:

a gas supply port for supplying, into a chamber, a first gas containing an organic compound including an oxygen atom and a second gas containing oxygen molecules; and

a light source that emits ultraviolet light exhibiting intensity in a wavelength region of 205 nm or less toward the first gas and the second gas supplied through the gas supply port,

wherein an object to be processed is brought into contact with the first gas that has been irradiated with the ultraviolet light and the second gas that has been irradiated with the ultraviolet light.

A mixed gas of the first gas and the second gas may be brought into contact with the object to be processed, and

at least one of the organic compound and oxygen gas contained in the first gas and the second gas may satisfy that a concentration thereof is less than a flammability limit. This prevents, when the first gas and the second gas are mixed, the mixed gas from being combusted or exploded.

The chamber may be constituted from at least two chambers,

the gas supply port may be constituted from a first gas supply port for supplying the first gas containing an organic compound including an oxygen atom and a second gas supply port for supplying the second gas containing oxygen molecules, and

the first gas supply port may be disposed in some of the at least two chambers, and the second gas supply port may be disposed in the chamber(s) other than the some of the at least two chambers.

The second gas may be air, and the gas supply port for supplying the second gas may be opened to the atmosphere. When the second gas is air, oxygen molecules in the atmosphere can be taken into the chamber by opening the gas supply port to the atmosphere.

The gas supply port may be disposed, for example, in the wall or ceiling of the chamber. When there is only one gas supply port, the gas supply port is usually connected to both of a supply source of the first gas and a supply source of the second gas. However, a combined supply source that supplies both the first gas and the second gas may be used. In this case, even when there is only one gas supply port, the supply port is connected to the combined supply source. When there is a plurality of gas supply ports, at least one of the gas supply ports may be connected to a supply source of the first gas and the other gas supply port(s) may be connected to a supply source of the second gas, or each of the plurality of gas supply ports may be connected to a supply source of the first gas and a supply source of the second gas. It should be noted that when the gas supply port is connected to the supply source, a gas supply channel such as a pipe may be interposed between the gas supply port and the supply source.

### Effect of the Invention

The present invention makes it possible to provide an improved method and device for modifying a fluororesin.

### BRIEF DESCRIPTION OF THE DRAWINGS

FIG. 1 is a diagram showing an embodiment of a fluororesin modification system.

FIG. 2A is a diagram illustrating a modification mechanism.

FIG. 2B is a diagram illustrating a modification mechanism.

FIG. 2C is a diagram illustrating a modification mechanism.

FIG. 2D is a diagram illustrating a modification mechanism.

FIG. 3 is a diagram illustrating a first modification of a gas supply source.

FIG. 4 is a diagram illustrating a second modification of a gas supply source.

FIG. 5 is a diagram illustrating a first modification of a modification device.

FIG. 6 is a diagram illustrating a second modification of a modification device.

FIG. 7A shows an XPS measurement result of an unprocessed sample.

FIG. 7B shows an XPS measurement result of a sample S3.

FIG. 7C is an XPS measurement result of a sample S5.

FIG. 8 is a diagram illustrating a conventional method for modifying a fluororesin.

### MODE FOR CARRYING OUT THE INVENTION

Embodiments of the present invention will be described with reference to the drawings. It should be noted that the drawings disclosed herein merely show schematic illustrations. Namely, the dimensional ratios on the drawings do not necessarily reflect the actual dimensional ratios, and the dimensional ratios are not necessarily the same between the drawings.

### [Outline of Modification System]

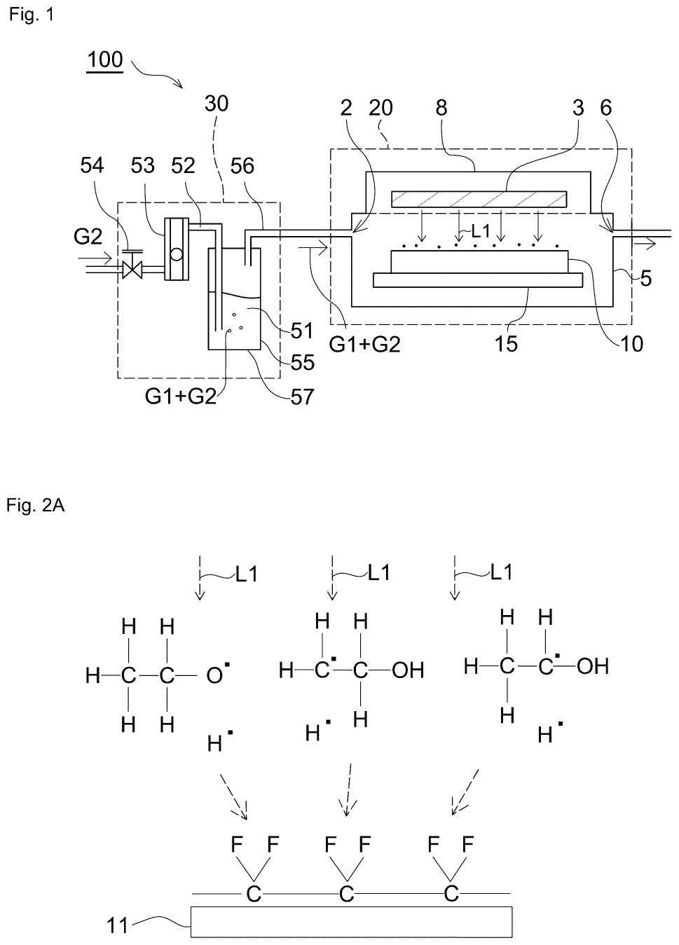

Hereinbelow, an embodiment of a fluororesin modification system and an embodiment of a method for modifying a fluororesin using the modification system will be described. FIG. 1 shows a fluororesin modification system. A fluororesin modification system 100 includes a modification device 20 and a gas supply source 30 that supplies a gas to the modification device 20.

The modification device 20 includes a light source 3 and a gas supply port 2 connected to the gas supply source 30. The gas supply source 30 supplies a first gas G1 containing an organic compound including an oxygen atom and a second gas G2 containing oxygen molecules to the modification device 20. The modification device 20 and the gas supply source 30 will be described later in detail.

Ultraviolet light L1 emitted from the light source 3 is vacuum ultraviolet light and is more specifically ultraviolet light exhibiting intensity in at least a wavelength region of 205 nm or less. The “ultraviolet light exhibiting intensity in at least a wavelength region of 205 nm or less” as used herein is light having an emission band at 205 nm or less. Examples of such light include (1) light exhibiting intensity in a broad wavelength region and showing an emission spectrum whose peak emission wavelength of maximum intensity is 205 nm or less, (2) light showing an emission spectrum having a plurality of maximum intensities (a plurality of peaks), in which any one of the plurality of peaks is located in a wavelength range of 205 nm or less, and (3) light showing an emission spectrum in which integrated intensity of light at 205 nm or less is at least 30% of total integrated intensity.

The light source 3 is, for example, a xenon excimer lamp. The peak emission wavelength of the xenon excimer lamp is 172 nm. Light emitted from the xenon excimer lamp is easily absorbed by the first gas G1 containing an organic compound including an oxygen atom and the second gas G2 containing oxygen molecules, and therefore many radicals are produced from the organic compound including an oxygen atom and from oxygen molecules.

### [Object to be Processed]

In the present embodiment, an object to be processed 10 is an object formed of a fluororesin as a whole. However, the object to be processed 10 may be an object not formed of a fluororesin as a whole. The object to be processed 10 is not limited as long as it has, in at least part of the surface thereof, a region where a fluororesin is exposed. The object to be processed 10 may be a rigid plate-shaped substrate, a long flexible film, or an object having a three-dimensional shape other than a plate shape.

Specific examples of the object to be processed 10 include medical fluororesins and printed-wiring boards for high-frequency applications. When the surface of a fluororesin is converted from hydrophobic to hydrophilic, joint strength between the fluororesin and another material can be enhanced. In the case of a printed-wiring board, for example, joint strength between a fluororesin as a base material and a copper plating film can be enhanced, and as a result, an effect that the copper plating is less likely to be peeled off is expected to be obtained.

### [Production of Radicals of First Gas by Modification Device]

The mechanism of production of radicals of the first gas by the optical processing device will be described. First, description will be made with reference to a case where an example of the organic compound including an oxygen atom is ethanol (C₂H₅OH). Chemical reaction formulas of the process of producing radicals by irradiating a molecule of ethanol with ultraviolet light (hv) are shown.

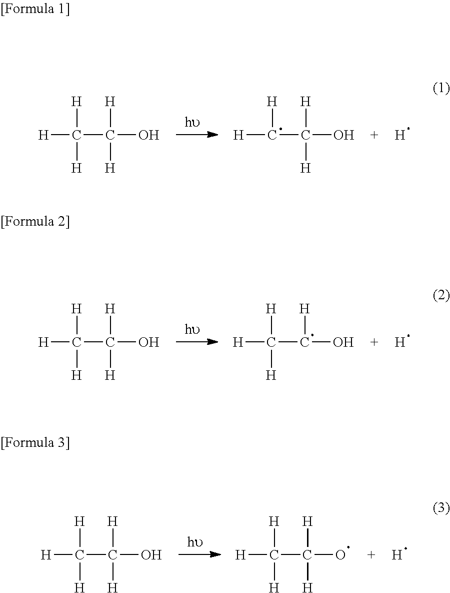

As shown by the above formulas (1) to (3), when a molecule of ethanol is irradiated with ultraviolet light (hv), energy of the ultraviolet light breaks a bond between atoms constituting the molecule of ethanol to produce a radical composed of a carbon atom, a hydrogen atom, and an oxygen atom (sometimes referred to as “{CHO} radical”) and a hydrogen radical (sometimes referred to as “H.”). The {CHO} radicals include one having radicalized C and one having radicalized O. Three types of {CHO} radicals shown in the above formulas (1) to (3) are formed depending on which of C and O is radicalized and which of the carbon atoms is radicalized. It is not always true that all the {CHO} radicals are produced in equal proportion.

It should be noted that each of the three chemical reaction formulas represented by the above formulas (1) to (3) shows a case where a {CHO} radical having one atom having an unpaired electron is produced. However, a {CHO} radical having two or more atoms each having an unpaired electron may be produced by irradiation with ultraviolet light.

### [Modification Mechanism]

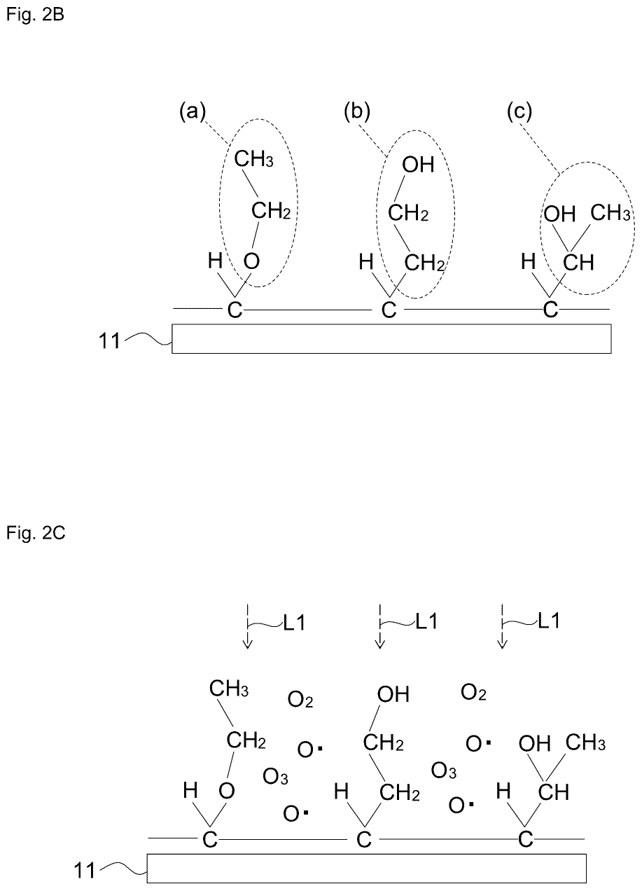

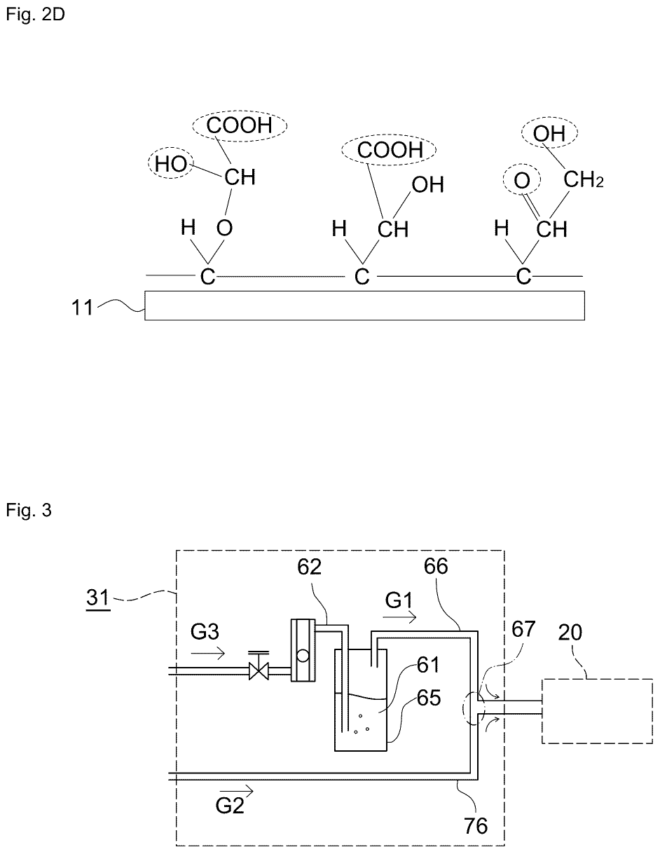

Referring to FIG. 2A to FIG. 2D, the modification mechanism of surface of the fluororesin through a first step and a second step will be described. FIG. 2A to FIG. 2D are schematic sectional diagrams of a fluororesin 11, which show the chemical structure of surface of the fluororesin 11 in an understandable way.

FIG. 2A shows a state where radicals are produced immediately before modification of a fluororesin 11 (here, PTFE). As shown in FIG. 2A, a large number of fluorine atoms (F) bonded to carbon atoms (C) are present on the surface of the fluororesin 11 before surface modification. In the vicinity of the surface of the fluororesin 11, {CHO} radicals and hydrogen radicals are produced from molecules of ethanol by absorption of ultraviolet light.

Fluorine atoms contained in the fluororesin 11 are in a state where they are bonded to carbon atoms. Binding energy between a carbon atom and a fluorine atom is as high as 485 KJ/mol, and therefore a very large amount of energy is required to separate the fluorine atom and the carbon atom by heat or light.

Here, the electronegativity of a fluorine atom is 4.0, and the electronegativity of a hydrogen atom is 2.2, both of the electronegativities are greatly different from each other. Therefore, electrostatic attraction allows the hydrogen radical to approach the fluorine atom to form HF (hydrogen fluoride), thereby breaking the bond between the fluorine atom and the carbon atom. Binding energy between a hydrogen atom and a fluorine atom is 568 KJ/mol that is higher, and HF is separated from the surface of the fluororesin as a gas, and therefore the production reaction of HF irreversibly proceeds. The {CHO} radical or the hydrogen radical is bonded to a site where fluorine has been extracted from the surface of the fluororesin 11.

FIG. 2B shows the state of the fluororesin 11 shown in FIG. 2A after surface modification by the {CHO} radicals and the hydrogen radicals. FIG. 2B illustrates a state where six fluorine atoms are extracted, hydrogen radicals are bonded to three sites among the sites of the six fluorine atoms, and {CHO} radicals are bonded to the other three sites, but fluorine atoms may remain on the surface. Further, the number of hydrogen radicals bonded may not be the same as the number of {CHO} radicals bonded. For example, {CHO} radicals may be bonded to all the sites where the fluorine atoms have been extracted. On at least part of the surface of the fluororesin 11, a functional group composed of a carbon atom, a hydrogen atom, and an oxygen atom (hereinafter sometimes referred to as “{CHO} functional group”) is present.

The {CHO} functional group represented by (a) in FIG. 2B is formed by bonding the {CHO} radical obtained by the above formula (3) to the fluororesin 11. The {CHO} functional group represented by (b) in FIG. 2B is formed by bonding the {CHO} radical obtained by the above formula (1) to the fluororesin 11. The {CHO} functional group represented by (c) in FIG. 2B is formed by bonding the {CHO} radical obtained by the above formula (2) to the fluororesin 11.

The {CHO} functional group bonded to the fluororesin 11 is polar. Each of the {CHO} functional groups represented by (b) and (c) in FIG. 2B has a hydroxy group at the terminal and therefore exhibits high hydrophilicity. The {CHO} functional group represented by (a) in FIG. 2B forms an ether bond with the fluororesin 11 and is therefore not as hydrophilic as a hydroxy group, but exhibits certain hydrophilicity. It should be noted that in FIG. 2B, different functional groups (a), (b), and (c) are adjacent to each other for explanatory convenience, but actually, the same functional groups may be adjacent to each other.

The ultraviolet light breaks the O═O bond of an oxygen molecule to produce an oxygen radical (hereinafter sometimes referred to as “O⋅”). Further, the produced oxygen radical may be bonded to an oxygen molecule O₂ to produce ozone (O₃). FIG. 2C shows a state where oxygen radicals produced from oxygen molecules and ozone approach the surface of the fluororesin 11.

The surface of the fluororesin 11 has a large number of hydrocarbon groups. The oxygen radical approaches a hydrogen atom contained in the hydrocarbon group so that the hydrogen atom is extracted from the hydrocarbon group. The oxygen radical or ozone approaches a site where hydrogen has been extracted from the hydrocarbon group so that an oxygen atom is bonded to the site. That is, the hydrocarbon group is oxidized by the oxygen radical or ozone.

FIG. 2D shows the state of the fluororesin 11 after surface modification by oxygen radicals and ozone produced from oxygen radicals. In FIG. 2D, a functional group surrounded by a dashed circle indicates an oxygen-based functional group replaced in the second step. Thus, the number of oxygen-based functional groups (COOH, OH, or CO) bonded to the hydrocarbon groups on the surface of the fluororesin increases. The oxygen-based functional group is polar and hydrophilizes the fluororesin. Further, the oxygen radicals are bonded to oxygen molecules to produce ozone (see FIG. 2C). Ozone also has oxidizing power, though the oxidizing power is weaker than that of the oxygen radical.

In the modification mechanism, the second step proceeds after the first step in principle. However, both the first step and the second step locally proceed in the chamber in a short period of time. Therefore, the first step and the second step may actually be performed at the same time. This will be described later in detail.

It should be noted that a reaction to produce radicals by irradiating a gas with ultraviolet light proceeds irrespective of pressure, and therefore it is not always necessary to create a reduced-pressure environment in the chamber that is a reaction field. However, in order to replace an atmosphere in the chamber 5 with a desired gas atmosphere in a short time, a vacuum pump may be connected to a gas discharge port 6 to reduce the pressure in the chamber 5.

This is the modification mechanism of surface of the fluororesin through a first step and a second step. The section “Production of radicals of first gas by modification device” and the section “Modification mechanism” have been described with reference to a case where an example of the organic compound including an oxygen atom is ethanol (C₂H₅OH). However, the first gas is not limited to this example, and any gas can be used for hydrophilization in the first step as long as it contains an organic compound including an oxygen atom.

However, the organic compound including an oxygen atom preferably contains at least one of a hydroxy group, a carbonyl group, and an ether bond. In this case, a functional group containing at least one of a hydroxy group, a carbonyl group, and an ether bond can be formed on the surface of the fluororesin, and therefore high hydrophilicity can be imparted to the surface of the fluororesin. Particularly, the organic compound including an oxygen atom preferably contains at least one selected from the group consisting of an alcohol, a ketone, an aldehyde, a carboxylic acid, and a phenol. Further, the organic compound including an oxygen atom preferably contains at least one selected from the group consisting of an alcohol having 10 or less carbon atoms and a ketone having 10 or less carbon atoms. Among them, an alcohol having 2 or more and 4 or less carbon atoms and acetone are excellent in easy availability and economic efficiency. Particularly, an alcohol having 2 or more and 4 or less carbon atoms is excellent in safety and ease of handling. Acetone has a high vapor pressure, which makes it easy to form a relatively high concentration atmosphere.

### [Gas Supply Source]

Referring to FIG. 1, the gas supply source 30 in the present embodiment will be described. The gas supply source 30 includes a container 55 that stores ethanol 51 and a second gas supply pipe 52 that supplies a second gas G2 containing oxygen molecules to the ethanol 51 in the container 55. The ethanol 51 can be vaporized by bubbling by feeding the second gas G2 into the ethanol 51. As a result, both of oxygen gas contained in the second gas G2 and ethanol gas contained in the ethanol 51 can be extracted at the same time and fed to the modification device 20 through a gas supply pipe 56. In this case, the first step and the second step can be performed at the same time in the modification device 20.

The gas supply source 30 can adjust a mixing ratio between the first gas G1 and the second gas G2 in a mixed gas in the modification device 20 by adjusting the amount, temperature, or ethanol concentration of the ethanol 51. The amount of the second gas G2 to be supplied can be adjusted using a valve 54 by checking a flowmeter 53. A supply pipe may be provided to supply the ethanol 51 to the container 55. A discharge pipe may be provided to discharge the ethanol 51 from the container 55. A heater may be provided to control the temperature of the ethanol 51 in the container 55. The ethanol 51 used in the present embodiment is anhydrous ethanol, but an aqueous ethanol solution may be used. It should be noted that anhydrous ethanol herein refers to high-concentration ethanol containing 95 vol % or more of ethanol.

### [Concentrations of First Gas and Second Gas]

The above-described gas supply source 30 produces a mixed gas of the first gas G1 and the second gas G2. The mixed gas of the first gas G1 containing an organic compound including an oxygen atom (hereinafter sometimes simply referred to as “organic compound”) and the second gas G2 containing oxygen molecules may be combusted (explosion is also included: the same applies hereinafter) by imparting some kind of thermal energy or the like thereto. There are two methods to prevent combustion.

The first method is a method in which a mixed gas of the first gas G1 and the second gas G2 is never allowed to be produced. That is, after the completion of modification processing by the first gas G1 (first step), modification processing by the second gas G2 (second step) is performed. Alternatively, the first step and the second step may be performed in different chambers to prevent the production of the mixed gas.

The second method is a method in which the concentration of at least one of the organic compound and oxygen gas in the mixed gas is reduced to a value less than a flammability limit. This method is particularly suitable in a case where mixing of the first gas G1 and the second gas G2 cannot be avoided, such as a case where ethanol is subjected to bubbling using a gas containing oxygen molecules as described above or a case where the first step and the second step are performed at the same time in the same chamber.

The flammability limit of the organic compound refers to a minimum concentration of the organic compound at which when the organic compound is mixed with oxygen gas, combustion may occur by imparting some kind of thermal energy or the like thereto. The flammability limit of oxygen gas refers to a minimum concentration of oxygen gas at which when oxygen gas is mixed with the organic compound, combustion may occur by imparting some kind of thermal energy or the like thereto. When the concentration of one of the organic compound and oxygen gas is less than the flammability limit, combustion does not occur even when the first gas G1 and the second gas G2 are mixed and some kind of thermal energy or the like is imparted to the mixed gas. In order to reduce the concentration of the organic compound or oxygen gas in the mixed gas, an inert gas may be added to the first gas G1 or the second gas G2 before mixing.

For example, the flammability limit of oxygen gas in ethanol at ordinary temperature and pressure is 10.5%. When ethanol gas is present at ordinary temperature and pressure in the mixed gas of the first gas G1 and the second gas G2 (G1+G2), irrespective of the concentration of ethanol, combustion can be prevented by reducing the concentration of oxygen in the mixed gas to less than 10.5%. Therefore, an inert gas such as nitrogen gas may be added to the first gas G1 or the second gas G2 before mixing so that the concentration of oxygen in the mixed gas is less than 10.5%. The concentration of oxygen in the mixed gas (G1+G2) may be 20% or less and is preferably 10% or less, more preferably 5% or less.

The above-described method for reducing the concentration of at least one of the organic compound and oxygen gas to a value less than the flammability limit is an example. Another example is, for example, a method in which the pressure or temperature of the mixed gas is reduced.

### [Modification Device]

Referring to FIG. 1, details of the modification device 20 will be described. The modification device 20 includes a gas supply port 2 connected to the gas supply source 30, a light source 3, a chamber 5 in which an object to be processed 10 can be disposed, a table 15 on which an object to be processed 10 is to be placed, and a gas discharge port 6 to discharge a gas from the chamber 5. In the case of the present embodiment, the light source 3 is disposed in a light source chamber 8 disposed on the chamber 5, and the light source chamber 8 and the chamber 5 are separated by a translucent material such as quartz glass.

The modification device 20 is used, for example, in the following procedure. An object to be processed 10 is placed on the table 15 by a transport mechanism (not shown). A first gas G1 and a second gas G2 are supplied into the chamber 5 through the gas supply port 2 to replace air in the chamber 5 with the first gas G1 and the second gas G2. After the completion of the replacement, modification processing is performed by turning on the light source 3 while the first gas G1 and the second gas G2 are continued to be supplied to the chamber 5. After the completion of the modification processing, the light source 3 is turned off, supply of the first gas G1 and the second gas G2 is stopped, and the object to be processed 10 on the table 15 is taken out.

### [Modifications]

The gas supply source and the modification device may variously be modified. Modifications of the gas supply source and the modification device will be shown.

Referring to FIG. 3, a first modification of the gas supply source will be described. A gas supply source 31 includes a container 65 that stores ethanol 61.

A carrier gas supply pipe 62 is inserted into the ethanol 61, and a carrier gas G3 is fed through the carrier gas supply pipe 62 to vaporize the ethanol 61 by bubbling and then to extract ethanol gas. At this time, a first gas G1 contains the ethanol gas and the carrier gas G3. As the ethanol 61, anhydrous ethanol or an aqueous ethanol solution may be used. In the present modification, the carrier gas G3 may be an inert gas such as nitrogen gas.

A second gas G2 is a gas containing oxygen molecules. The second gas G2 is added to the produced first gas G1 to produce a mixed gas (G1+G2). A pipe 66 through which the first gas G1 flows and a pipe 76 through which the second gas G2 flows are connected to the modification device 20 through a joint portion 67. As the second gas G2, oxygen gas or air may be used. When air in the atmosphere is used, the atmosphere may be fed to the pipe 76 using a blower or the like. In order to reduce the concentration of oxygen in the second gas G2, an inert gas such as nitrogen gas may be added when the second gas G2 is produced.

As can be seen from FIG. 3, the mixed gas (G1+G2) in the present embodiment contains also the carrier gas G3. The mixing ratio between the first gas G1 and the second gas G2 can be adjusted by adjusting the flow rate ratio between the second gas G2 and the carrier gas G3. At the joint portion 67, a flow rate adjusting valve may be disposed to adjust the mixing ratio between the two gases.

In the case of this modification, the timing of supply of the first gas G1 can be made different from the timing of supply of the second gas G2. For example, only the second gas G2 can be fed to the modification device 20 by flowing only the second gas G2 without flowing the carrier gas G3. On the other hand, only the first gas G1 can be fed to the modification device 20 by flowing the carrier gas G3 to produce the first gas G1 and stopping the supply of the second gas G2. At the joint portion 67, a three-way valve may be disposed to switch flow between the two gases. By making the timing of supply of the first gas G1 different from the timing of supply of the second gas G2, mixing of the first gas G1 and the second gas G2 is prevented. As described above, combustion of the first gas G1 can be prevented by preventing mixing of the first gas G1 and the second gas G2.

Alternatively, the first gas G1 may be replaced with an inert gas by connecting an inert gas supply pipe to the modification device 20 and feeding an inert gas to the chamber before supplying the second gas G2 and after stopping the supply of the first gas G1.

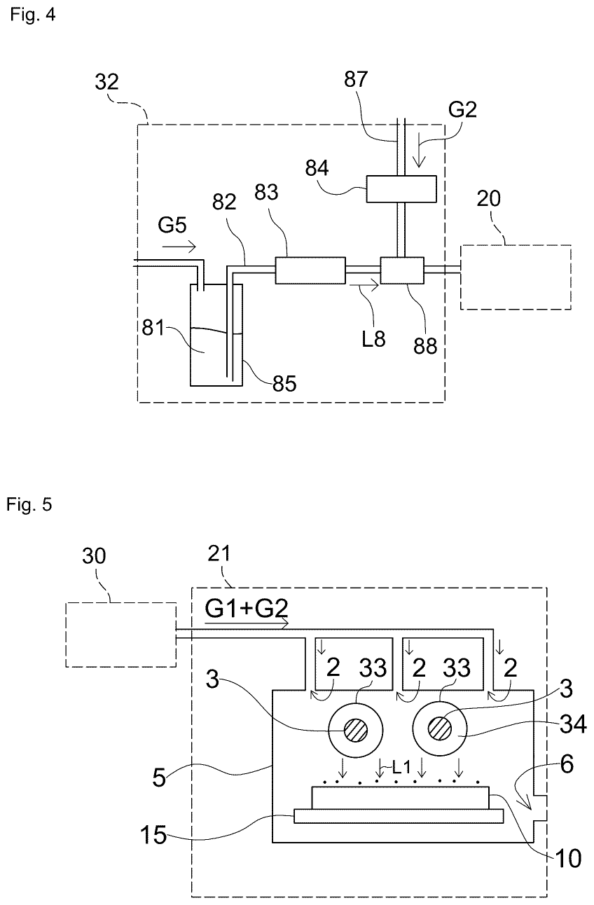

Referring to FIG. 4, a second modification of the gas supply source will be described. A gas supply source 32 adopts a direct vaporization system. The gas supply source 32 includes a container 85 that stores ethanol 81, a supply pipe 87 to flow a second gas G2, a vaporizer 88, a mass flow controller 83 to control the amount of the ethanol 81, and a mass flow controller 84 to control the amount of the second gas G2.

Using the mass flow controllers (83, 84), a certain amount of the second gas G2 and a certain amount of the ethanol 81 are supplied to the vaporizer 88. The vaporizer 88 immediately vaporizes all the supplied ethanol 81 using the supplied second gas G2. It should be noted that as shown in FIG. 4, the ethanol 81 can be extracted by feeding a pressure-feeding gas G5 to the container 85 that stores the ethanol 81. The ethanol 81 is anhydrous ethanol, but an aqueous ethanol solution may be used as the ethanol 81.

Referring to FIG. 5, a first modification of the modification device will be described. In a modification device 21, two light sources 3 are disposed in such a manner that the longitudinal direction of each of the light sources 3 is parallel to a direction from the front to back of the drawing. A plurality of gas supply ports 2 for a first gas G1 and a second gas G2 are provided in the ceiling of a chamber 5 so that an object to be processed 10 can evenly be processed. In consideration of the flow of the first gas G1 and the second gas G2, the positions and number of the gas supply ports 2 can be set. Also, the positions and number of gas discharge ports 6 can be set.

Each of the light sources 3 is housed in a tube 33 that extends from the front to back of the drawing. At least part of the tube 33 opposed to the object to be processed 10 is made of a material that transmits ultraviolet light L1, such as quartz glass. A space 34 between the light source 3 and the tube 33 is filled with an inert gas that is less likely to absorb ultraviolet light. The tube 33 prevents an altered substance of the organic compound contained in an atmosphere from adhering to the surface of the light source 3 to prevent a reduction in the irradiance of the light source 3.

As shown in FIG. 5, the first gas G1 and the second gas G2 may be fed into the chamber 5 at the same time as a mixed gas (G1+G2). Alternatively, the second gas G2 may be fed into the chamber 5 after the first gas G1 is fed into the chamber 5. Further alternatively, the first step and the second step may be performed in different chambers.

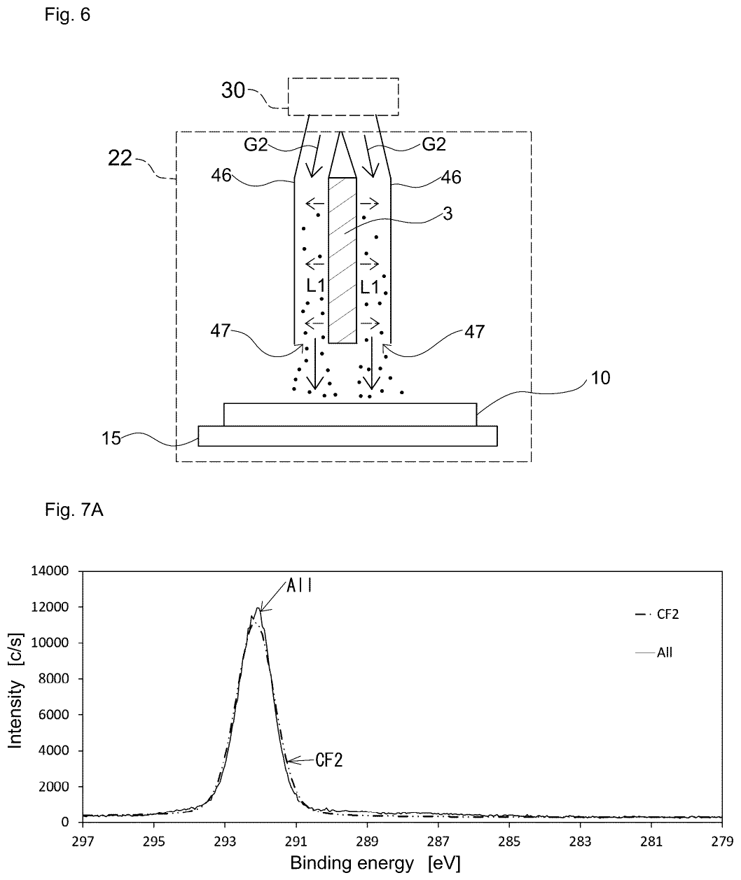

Referring to FIG. 6, a second modification of the modification device will be described. In a modification device 22, a second gas G2 passing through a pipe 46 is irradiated with ultraviolet light L1. In this way, oxygen molecules contained in the second gas G2 are radicalized. Then, the gas containing radicals is sprayed from a tip 47 of the pipe 46 toward the surface of an object to be processed 10. When the surface of a fluororesin of the object to be processed 10 comes into contact with the radicals, a hydrophilized layer is formed in the surface.

In the present modification, only a region required to be subjected to surface modification can selectively be processed by relatively moving the object to be processed 10 and the tip 47 while maintaining a gap between the object to be processed 10 and the tip 47 of the pipe 46. Further, in the present modification, an entire processing space surrounded by a chamber or the like may not be filled with the second gas G2. It should be noted that the modification device 22 can be used in the same manner also when a first gas G1 is used and when a mixed gas of the first gas G1 and the second gas G2 is used.

The embodiment of the modification system and the modifications of the gas supply source and the modification device constituting the modification system have been described above. However, the present invention is not limited to the embodiment and modifications described above, and two or more of the modifications may be combined and various changes or modifications may be made to the embodiment and the modifications without departing from the spirit of the present invention.

### EXAMPLES

The effect of the above-described modification method was verified by an experiment. Five PTFE (polytetrafluoroethylene) substrates manufactured by Yodogawa Hu-Tech Co., Ltd. were prepared as objects to be processed 10 and processed under different conditions.

### [First Step]

Common processing conditions of the first step are as follows. In the chamber 5, the substrate was disposed at a distance of 1 mm from the light source 3. As the light source 3, a xenon excimer lamp having a peak wavelength of 172 nm was used. The irradiance on the surface of the light source 3 was 30 mW/cm².

Nitrogen gas was fed at 2 L (2×10⁻³ m³)/min as the carrier gas G3 to vaporize ethanol in the container 55 by bubbling. In this experiment, the carrier gas G3 contains no oxygen molecule, and therefore the first step is performed prior to the second step. In the first step, the samples S1 and S2 were irradiated with light for 60 seconds, and the samples S3 to S5 were irradiated with light for 120 seconds.

### [Second Step]

After the completion of the first step, the samples S2, S4, and S5 were subjected to the second step. Common processing conditions of the second step are as follows. In the chamber 5, the substrate was disposed at a distance of 1 mm from the light source 3. As the light source 3, a xenon excimer lamp having a peak wavelength of 172 nm was used. The irradiance on the surface of the light source 3 was 30 mW/cm².

A gas supply port to supply air as the second gas G2 to the chamber was provided by opening the chamber 5 to the atmosphere. In this way, the object to be processed 10 is exposed to an air atmosphere containing about 21% of oxygen.

Under such conditions, the samples S2 and S4 were irradiated with light for 2 seconds, and the sample S5 was irradiated with light for 10 seconds. It should be noted that the samples S1 and S3 were not subjected to the second step.

### [Contact Angle Measurement]

The water contact angle of the object to be processed before processing and the water contact angle of each of the samples S1 to S5 after the above-described processing were measured. A smaller water contact angle indicates that the degree of hydrophilization is higher. In order to measure a water contact angle, a contact angle meter DMs-401 manufactured by Kyowa Interface Science Co., Ltd. was used. From a measurement result obtained by the contact angle meter, a contact angle was calculated by elliptical curve fitting. The calculation of contact angle was performed on three points on the surface of the same object to be processed 4. The average of water contact angles measured at three points was calculated and defined as a final water contact angle. The other measurement conditions of the water contact angle were set in accordance with JIS R 3257 “Method for Testing Wettability of Substrate Glass Surface”. The measurement results are shown in Table 1.

TABLE 1

| | | Water |
|---|---|---|
| | | contact |
| | | angle |
| Sample | | [deg.] |
| Unprocessed sample | | 119 |
| Sample S1 | First step 60 sec | 82 |
| Sample S2 | First step 60 sec/Second step 2 sec | 69 |
| Sample S3 | First step 120 sec | 57 |
| Sample S4 | First step 120 sec/Second step 2 sec | 43 |
| Sample S5 | First step 120 sec/Second step 10 sec | 32 |

From the measurement results shown in Table 1, the following (a) to (d) were found.
(a) Hydrophilization proceeds by performing the first step.
(b) Hydrophilization more proceeds by performing the first step for 120 seconds than by performing the first step for 60 seconds.
(c) Hydrophilization more proceeds by performing the second step in addition to the first step.
(d) Hydrophilization more proceeds by performing the second step for 10 seconds than by performing the second step for 2 seconds.

### [Xps Measurement]

Then, the surface of the unprocessed sample, the sample S3, and the sample S5 was measured by XPS (X-ray photoelectron spectroscopy). The XPS measurement was performed using PHI QuanteraII manufactured by ULVAC-PHI, Inc. Table 2 shows the ratio of the number of O atoms to the number of C atoms (hereinafter sometimes referred to as “O/C ratio”) calculated from the measurement result of XPS.

TABLE 2

| | | O/C |
|---|---|---|
| Sample | | ratio |
| Unprocessed sample | | 0 |
| Sample S3 | First step 120 sec | 0.199 |
| Sample S5 | First step 120 sec/Second step 10 sec | 0.340 |

As can be seen from Table 2, the O/C ratio of the unprocessed sample is 0. This results from the fact that C atoms as the denominator were detected, but O atoms as the numerator were not detected. On the other hand, it can be seen that O atoms were detected from the sample S3. Further, the O/C ratio of the sample S5 is higher than that of the sample S3, from which it can be seen that a larger number of O atoms were detected from the sample S5 than from the sample S3. From this, it is confirmed that oxygen-based functional groups are added to the surface of the sample by performing the first step, and the number of oxygen-based functional groups on the surface of the sample is increased by performing the second step.

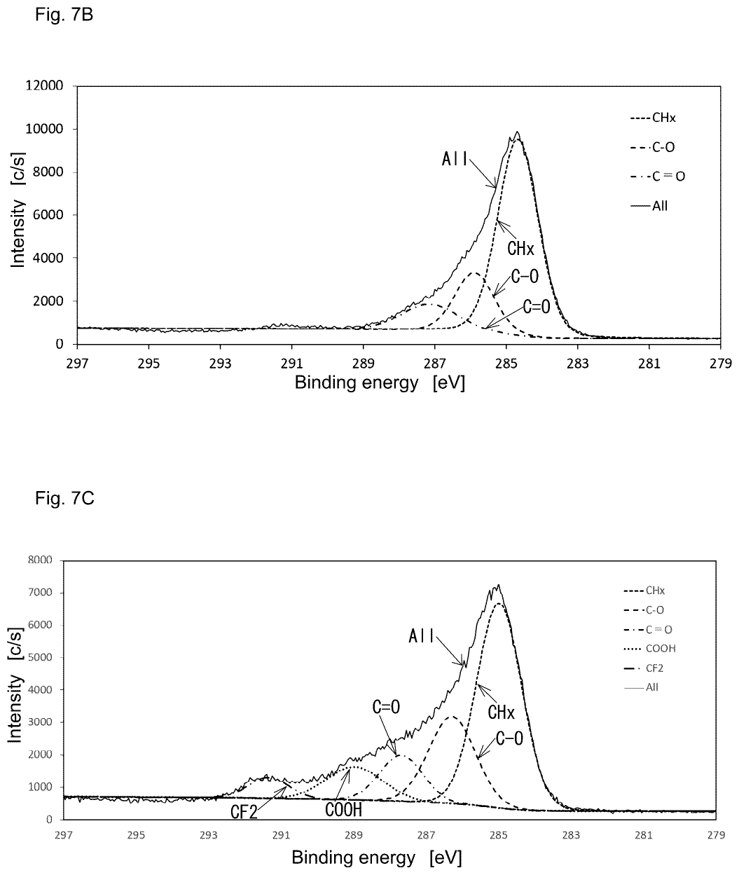

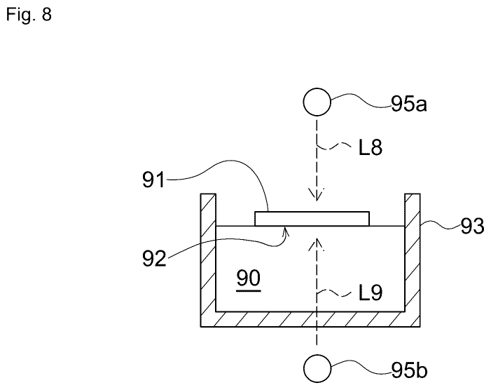

FIG. 7A shows a C1s spectrum obtained by XPS measurement of the unprocessed sample and the result of waveform separation of the C1s spectrum. FIG. 7B shows a C1s spectrum obtained by XPS measurement of the sample S3 and the result of waveform separation of the C1s spectrum. FIG. 7C shows a C1s spectrum obtained by XPS measurement of the sample S5 and the result of waveform separation of the C1s spectrum. In each of FIG. 7A, FIG. 7B, and FIG. 7C, a line marked with “All” indicates the C1s spectrum. In these drawings, spectra of elements obtained by waveform separation of the C1s spectra are shown. The integrated value of spectrum of each of the elements is positively correlated with the amount of functional group of the element.

As can be seen from FIG. 7A, only a CF2 element was substantially detected from the unprocessed sample. As can be seen from FIG. 7B, a CHx element, a C—O element, and a C═O element were detected from the sample S3. From this, it was found that F on the surface of the fluororesin was replaced with the organic compound including an oxygen atom by performing the first step. The C—O element and the C—O element observed in FIG. 7B are hydrophilic functional groups. From this, it was found that hydrophilization proceeded by performing the first step.

As can be seen from FIG. 7C, a COOH element was detected from the sample S5 in addition to a CHx element, a C—O element, and a C═O element. A COOH group is a functional group that exhibits especially high hydrophilicity. From this, it was found that the amount of COOH groups was increased by performing the second step so that hydrophilization proceeded.

It should be noted that in FIG. 7C, a CF2 element, which was not observed in FIG. 7B, was observed. The reason for this is considered to be that the organic compound including an oxygen atom, which had been added to the surface in the first step, was partially removed by oxygen radical or ozone by performing the second step so that CF2 present in a layer lower than sites where the organic compound had been removed was detected. Exposure of CF2 results in hydrophobization. However, in the case of the sample S5, hydrophilization is considered to have proceeded because the effect of hydrophilization caused by an increase in the amount of COOH groups is higher than the effect of hydrophobization caused by exposure of CF2. It is considered that when the processing time of the second step is made longer than necessary, the amount of the organic compound including an oxygen atom removed by oxygen radicals or ozone increases so that hydrophobization conversely proceeds due to an increase in exposure of CF2. There is an upper limit to the processing time of the second step.

### DESCRIPTION OF REFERENCE SIGNS

2 Gas supply port
3 Light source
5 Chamber
6 Gas discharge port
8 Light source chamber
10 Object to be processed
11 Fluororesin
15 Table
20, 21, 22 Modification device
30, 31, 32 Gas supply source
33 Tube
34 Space
46, 66, 76 Pipe
47 Tip
51, 61, 81 Ethanol
52 Second gas supply pipe
53 Flowmeter
54 Valve
55, 65, 75, 85 Container
56 Gas supply pipe
62 Carrier gas supply pipe
67 Joint portion
71 Water
83, 84 Mass flow controller
87 Supply pipe
88 Vaporizer
100 Modification system
G1 First gas
G2 Second gas
G3 Carrier gas
G5 Pressure-feeding gas
L1 Ultraviolet light

1. A method for modifying a fluororesin, the method comprising:
a first step in which a first gas containing an organic compound including an oxygen atom is irradiated with ultraviolet light exhibiting intensity in at least a wavelength region of 205 nm or less, and the first gas that has been irradiated with the ultraviolet light is brought into contact with a fluororesin; and
a second step in which a second gas containing oxygen molecules is irradiated with the ultraviolet light, and the second gas that has been irradiated with the ultraviolet light is brought into contact with the fluororesin.

2. The method according to claim 1, wherein after the first step, the first gas is discharged from a processing chamber before the second step is performed in the processing chamber.

3. The method according to claim 1, wherein the first step and the second step are performed at the same time by mixing the first gas and the second gas in such a manner that at least one of the organic compound and oxygen gas satisfies that a concentration thereof is less than a flammability limit, and
irradiating a mixed gas obtained by mixing the first gas and the second gas with the ultraviolet light.

4. The method according to claim 1, wherein at least one of the first step and the second step is performed by irradiating a gas in contact with the fluororesin with the ultraviolet light.

5. The method according to claim 1, wherein the second gas is air.

6. The method according to claim 1, wherein the organic compound contains at least one of a hydroxy group, a carbonyl group, and an ether bond.

7. The method according to claim 6, wherein the organic compound contains at least one selected from the group consisting of an alcohol, a ketone, an aldehyde, a carboxylic acid, and a phenol.

8. The method according to claim 7, wherein the organic compound contains at least one selected from the group consisting of an alcohol having 10 or less carbon atoms and a ketone having 10 or less carbon atoms.

9. The method according to claim 8, wherein the organic compound contains at least one selected from the group consisting of an alcohol having 2 or more and 4 or less carbon atoms and acetone.

10. The method according to claim 1, wherein the ultraviolet light is produced by a xenon excimer lamp.

11. A modification device comprising:
a gas supply port for supplying, into a chamber, a first gas containing an organic compound including an oxygen atom and a second gas containing oxygen molecules; and
a light source that emits ultraviolet light exhibiting intensity in a wavelength region of 205 nm or less toward the first gas and the second gas supplied through the gas supply port,
wherein an object to be processed is brought into contact with the first gas that has been irradiated with the ultraviolet light and the second gas that has been irradiated with the ultraviolet light.

12. The modification device according to claim 11, wherein a mixed gas of the first gas and the second gas is brought into contact with the object to be processed, and
at least one of the organic compound and oxygen gas contained in the first gas and the second gas satisfies that a concentration thereof is less than a flammability limit.

13. The modification device according to claim 11, wherein
the chamber is constituted from at least two chambers,
the gas supply port is constituted from a first gas supply port for supplying the first gas containing an organic compound including an oxygen atom and a second gas supply port for supplying the second gas containing oxygen molecules, and
the first gas supply port is disposed in some of the at least two chambers, and the second gas supply port is disposed in the chamber(s) other than the some of the at least two chambers.

14. The modification device according to claim 11, wherein the second gas is air, and the gas supply port for supplying the second gas is opened to the atmosphere.
